(19) United States
(12) Patent Application Publication
(10) Pub. No.: US 2026/0171651 A1
(43) Pub. Date: Jun. 18, 2026

(54) Launcher in Package - waveguide connection concept using advanced EBG structures for multi-chip radar systems

(71) Applicant: GM Cruise Holding LLC, San Francisco, CA (US)

(72) Inventors: Sebastian Mann, München (DE); Benedikt Schulte, Riedering (DE); Mathias Sattler, Starnberg (DE); Sebastian Westner, Raubling (DE)

(21) Appl. No.: 19/084,013

(22) Filed: Mar. 19, 2025

(30) Foreign Application Priority Data
Dec. 16, 2024 (DE) 102024138088.8

(51) Int. Cl. H01Q 1/22; G01S 7/03; H01Q 1/38; H01Q 1/50

(52) U.S. Cl. CPC H01Q 1/2283; G01S 7/032; H01Q 1/38; H01Q 1/50

(57) ABSTRACT

A radar sensor that uses electromagnetic band gap structures on a waveguide antenna surface is described. The radar sensor comprises a monolithic microwave integrated circuit (MMIC) and a printed circuit board (PCB) coupled to the MMIC. The radar sensor also comprises a waveguide antenna coupled to the PCB and having waveguide structures extending through the waveguide antenna to a surface of the waveguide antenna, the surface facing the PCB. The waveguide antenna also comprises double post electromagnetic band gap (EBG) structures disposed adjacent to and flush with broad sides of the waveguide structures on the surface of the waveguide antenna.

### BACKGROUND

Conventional autonomous or assisted driving strategies have been facilitated through sensing an environment around a vehicle. Radar sensors are conventionally used in connection with detecting and classifying objects in an environment. Radar is particularly robust with regard to lighting and weather conditions. Often, radar sensors are deployed with cameras and/or lidar sensors to provide different modes of detection and redundancy. In certain scenarios, performance of lidar and/or cameras can be supplemented by radar when affected by environmental features such as temperature, fog, rain, snow, bright sunlight, lack of adequate light, etc. Waveguides can be employed to assist in capturing and/or channeling high frequency signals, such as radar signals.

Automotive radar sensors employ numerous channels and/or antenna elements and a large aperture to enable high resolution capabilities. Many radar sensors use printed circuit board (PCB) based antenna arrays; however, transmission loss, routing flexibility, and costs dominate the arguments for using waveguide based antenna arrays for future sensor generations as an alternative. In combination with Launcher-in-Package (LiP, also called Antenna-in-Package) technology, the PCB can be designed using cost-effective material combinations, even standard flame-retardant 4 (FR4 ) material stacks can be employed. Commercial off-the-shelf (COTS) LiP radar monolithic microwave integrated circuits (MMICs) typically can feed up to four transmit channels and usually provide four receivers while some MMICs can feed eight transmit channels and eight receiver channels. Multiple MMICs can be used in high resolution sensors. For synchronization between MMICs, a local-oscillator signal can be distributed on the PCB.

Abnormalities can occur during manufacture of waveguides and PCBs, such as warping or the like. When one or both of the waveguide and the PCB is not planar, unintended gaps between the waveguide and the PCB can occur, which adversely affects radio frequency (RF) performance. Such gaps can also result in propagation of parallel plate modes and unintended mutual coupling between channels of an MMIC coupled to the PCB. Conventional approaches have not satisfactorily addressed problems created by such manufacturing abnormalities.

### SUMMARY

The following is a brief summary of subject matter that is described in greater detail herein. This summary is not intended to be limiting as to the scope of the claims.

Described herein are various technologies relating to employing double post electromagnetic band gap (EBG) structures on a surface of a waveguide antenna of a radar sensor to extend waveguide structures traversing the waveguide antenna. The waveguide antenna can be formed (e.g., using injection molding techniques or the like) to have waveguide structures (e.g., slots or the like) extending therethrough. In one embodiment, the waveguide structures terminate at a surface of the waveguide antenna that faces a printed circuit board (PCB) to which the wave guide is coupled in the radar sensor. The waveguide structures have a rectangular shape such that a waveguide aperture at the surface of the waveguide antenna has two sides that are longer (broad sides) than the other two sides (narrow sides). To account for unintended gaps between the waveguide antenna and the PCB, which may occur due to manufacturing abnormalities or the like, a double post EBG structure is positioned adjacent to and flush with each broad (longer) side of the wave guide aperture.

The double post EBG structures can be formed on the surface of the wave guide antenna next to the waveguide structure apertures during the injection molding process (i.e., formed of the same material as the wave guide antenna). The double post EBG structure comprises a first post, a second post, and a bridge portion connecting the two posts. In one embodiment, the bridge portion can be approximately half as tall as the posts. In another embodiment, the height of the bridge portion is in the range of, e.g., 0.4-0.6 times the height of the posts. The shape of the posts can be, e.g., cylindrical, columnar, etc. The posts can also have chamfered tops and/or sidewalls.

The shape of the double post EBG structure induces a plurality of resonator modes that provide a band gap in which the waveguide antenna can operate. For instance, in an example where the double post EBG structure has five resonator modes, the band gap can be provided between a second and a third resonator mode. In one example, the band gap lies between approximately 70 GHz and 120 GHz.

According to another embodiment, contact points on the waveguide antenna and/or the PCB are arranged to ensure alignment between an EBG region (wherein the waveguide structure apertures and the double post EBG structures are located) on the waveguide antenna with one or more monolithic microwave integrated circuits (MMICs) disposed on an opposite side of the PCB to which the waveguide antenna is coupled. The contact points can be positioned to be equidistant from a geometric center of the wave guide antenna, the EBG region, the MMIC, and/or the PCB. The PCB and waveguide antenna are coupled together at the contact points. Therefore it is desirable to ensure that a sufficient number of contact points are provided to keep all components of the radar sensor firmly in position relative to each other. Additionally, by employing a minimum number of contacts to achieve the foregoing goal, mechanical stresses associated with thermal expansion and the like can be mitigated.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a double post electromagnetic band gap (EBG) structure, in accordance with one or more features described herein.

FIG. 2 is a diagram of an EBG circuit showing the resonant characteristics of the EBG structure, in accordance with one or more features described herein.

FIG. 3 illustrates a graph of different resonator modes exhibited by the EBG structure, in accordance with one or more features described herein.

FIG. 4A shows a top down view and a side view of the EBG structure with cylindrical posts.

FIG. 4B shows a top down view and a side view of the EBG structure with columnar posts.

FIG. 4C shows a top down view and a side view of the EBG structure wherein the posts are columnar with chamfered sidewalls.

FIG. 4D shows a top down view and a side view of the EBG structure wherein the posts are cylindrical with chamfered tops.

FIG. 4E shows a top down view and a side view of the EBG structure wherein the posts are columnar with chamfered tops.

FIG. 4F shows a top down view and a side view of the EBG structure wherein the posts are columnar with chamfered tops and sidewalls.

FIG. 5 a cutaway view of a portion of a radar sensor that employes the described EBG structure, in accordance with one or more features described herein.

FIG. 6 illustrates a graph showing reflection loss for a conventional EBG structure and the herein-described double post EBG structure.

FIG. 7 shows a top down view of the waveguide structure with double post EBG structures positioned against the broad sides of the waveguide structure.

FIG. 8 illustrates a portion of an injection molded waveguide antenna, in accordance with one or more features described herein.

FIG. 9 illustrates a cross-sectional view of a radar sensor comprising the waveguide antenna coupled to a PCB, which in turn is coupled to an MMIC.

FIG. 10 is an illustration of a radar sensor showing the waveguide antenna coupled to the PCB at a contact surface.

FIG. 11 illustrates a radio frequency (RF) chip positioned between two contact points for coupling a waveguide to a PCB, in accordance with one or more features described herein.

FIG. 12 illustrates a radio frequency (RF) chip positioned between three contact points for coupling a waveguide to a PCB, in accordance with one or more features described herein.

FIG. 13 illustrates a waveguide antenna having disposed thereon waveguide structures with double post EBG structures positioned flush with the broad sides of the ends of the waveguide structures.

FIG. 14 illustrates a radio frequency (RF) chip positioned between two contact points for coupling a waveguide to a PCB, in accordance with one or more features described herein.

FIG. 15 illustrates a waveguide antenna having disposed therethrough waveguide structures with double post EBG structures positioned adjacent to and flush with the broad sides of the ends of the waveguide structures.

FIG. 16 illustrates a waveguide antenna having disposed thereon waveguide structures with double post EBG structures positioned flush with and adjacent to the ends of the broad sides of the waveguide structures.

FIG. 17 illustrates a four-chip arrangement that uses eight contact points, in accordance with one or more features described herein.

FIG. 18 illustrates a four-chip arrangement that uses four contact points, in accordance with one or more features described herein.

FIG. 19 illustrates a two-chip arrangement that uses four contact points, in accordance with one or more features described herein.

FIG. 20 illustrates a two-chip arrangement that uses four contact points, in accordance with one or more features described herein.

FIG. 21 illustrates a four-chip arrangement that uses four contact points, in accordance with one or more features described herein.

FIG. 22 illustrates a four-chip arrangement that uses four contact points, in accordance with one or more features described herein.

FIG. 23 illustrates a methodology for manufacturing a waveguide antenna having disposed on a surface thereof waveguide structures with double post EBG structures positioned adjacent the broad (longer) sides of the ends of the waveguide structures.

### DETAILED DESCRIPTION

Various technologies pertaining to electromagnetic band gap devices for waveguide antennas are described herein. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Cost efficient 3D-waveguide antennas are often composed of multiple layers which are produced, for example, by plastic injection molding, conductively coated, and finally joined e.g. by a soldering or conductive gluing process. Dependent on the manufacturer of the parts, a planarity of, e.g., ±100 μm is reasonable for the production of such antenna parts providing a large aperture. Additionally, the planarity of the PCB is often limited after the assembly process. A planar gapless conductive connection to the radio frequency (RF) board with multiple MMICs is therefore difficult to achieve without introducing an undesirably high mechanical stress to both components. Therefore, it becomes desirable to employ a limited number of connection points between the PCB and the antenna.

Some RF radar MMICs use LiP technology to support the usage of 3D waveguide antennas. A popular type of 3D waveguide antenna involves feeding the waveguide channels through a metallized cutout in the PCB, which is acts as a waveguide. A good connection between the waveguide and PCB occurs when the waveguide is continued with an ideal electrical connection. During manufacturing, non-planarity of one or both of the PCB or the antenna can occur and can introduce unintended gaps between the waveguide structures, thus impacting the RF performance (reflection loss and insertion loss) of this transition. This, in turn, can result in a propagation of parallel plate modes and unintended mutual coupling between the channels of the MMIC. Electromagnetic band gap (EBG) structures can be used to allow for unintended gaps without resulting in undesirably high interchannel coupling and unpredictably disrupted transition.

Waveguide transitions with EBG structures designed to avoid coupling between channels may struggle with regard to return loss when compared to the ideal waveguide interface, as current distribution in the broad side of the waveguide structure (i.e., the longer side of the waveguide structure) is severely disturbed. This also increases the transmission loss of the transmit and receive signals to and from the MMIC with launcher-in-package technology. Usage of EBG structures in general allows a low loss connection between the perfect electric conductor and the perfect magnetic conductor created by the EBG structure. Single post EBG structures can be characterized by the band gap between the 1st and the higher resonator modes. However, the density of single post EBG structures replacing an ideal waveguide wall would need to be very dense and is hard to be manufactured at high frequencies.

The described problems are solved by employing a double post EBG structure that uses a higher mode band gap than a conventional single post EBG, for example between the 2nd and the 3rd resonator modes of the structure. The double post EBG is shaped so that the broad side waveguide structure wall at the interface between a 3D waveguide antenna and the PCB can be continued for a longer distance, thereby reducing insertion loss and improving the return loss (e.g., matching) of the structure. The described double post EBG structure being flush with the waveguide structure walls improves transmission and reflection loss by continuing the broad side waveguide structure wall by design. The described double post EBG structure is a multi-chip capable solution that can tolerate varying gaps between antenna and PCBs and offsets between the waveguide antenna and PCB. The described EBG structure also works with launcher-in-package technology without excluding other launching methods.

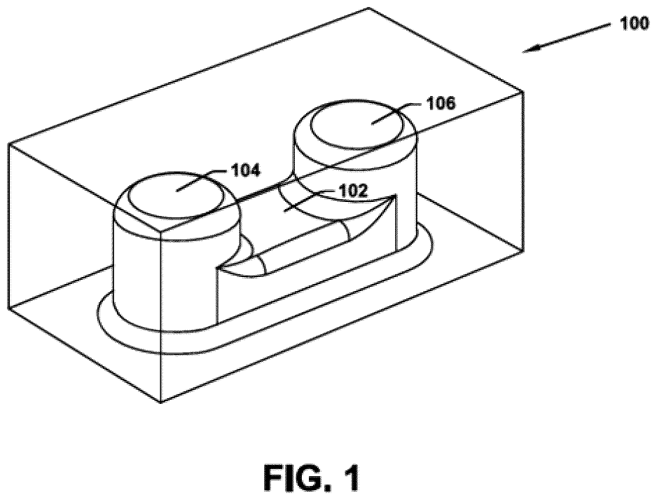

With reference now to FIG. 1, a double post electromagnetic band gap (EBG) structure 100 is illustrated, in accordance with one or more features described herein. The EBG structure 100 comprises a bridge portion 102 that extends between a first post 104 and a second post 106. The bridge portion 102, the first post 104, and the second post 106 can be comprised of a single material. In one embodiment, the material is a waveguide material such as is used for generating waveguides for, e.g., radar sensors. The material can be a conductive material, such as nickel, aluminum, copper, silver, or gold. According to another example, the material can be a conductive stack, a conductive coating, or the like. The conductive stack, for instance, can be formed via injection molding. The EBG structure 100 generates different resonator modes that exhibit a band gap region in which signal transmission can occur. The EBG structure 100 facilitates providing a contactless transition between a waveguide and a printed circuit board (PCB), such as can be employed in, e.g., a radar sensor. EBG structure 100 is not limited to the shape illustrated in FIG. 1, but rather can comprise other shapes as are discussed herein. In one embodiment, the EBG structure 100 exhibits at least three resonator modes, with at least two of the resonator modes having a substantially lower resonator stop frequency than the third resonator mode, thereby opening a band gap in the operational frequency range.

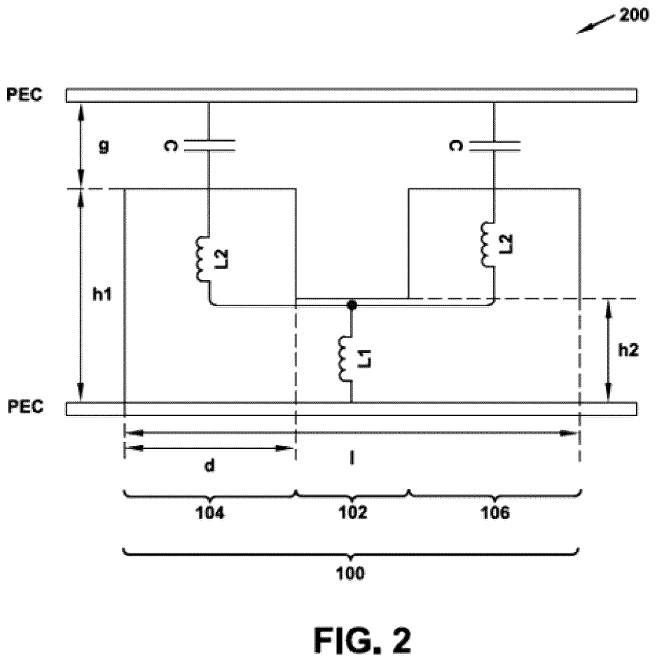

FIG. 2 is a diagram of an EBG circuit 200 showing the resonant characteristics of the EBG structure 100 (FIG. 1), in accordance with one or more features described herein. The EBG circuit 200, for illustrative purposes, is positioned between two perfectly electric conductors (PEC). A first inductance L₁ represents a resonant characteristic of the bridge portion 102 (FIG. 1). A second inductance L₂ and a capacitance C represent the resonant characteristics for the first and second posts 104, 106 (FIG. 1). The L₂C resonant circuits of the first and second posts 104, 106 (FIG. 1) are coupled to each other in parallel, and serially coupled to the inductance L₁ of the bridge portion 102 (FIG. 1).

Several EBG structure dimensions are also shown in FIG. 2. An overall length l of the EBG structure 100 is shown, as is a diameter d of the posts 104, 106, a height h₁ of the posts, and a height h₂ of the bridge portion 102. A gap distance g between the top of the posts 104, 106 and an upper PEC layer is also labeled.

According to one example, for a given wavelength λ to be transmitted and/or received by a radar sensor employing the EBG structure 100, the EBG structure 100 can be designed so that the dimension of the gap g is given as: g<<λ/4. The diameter d is given as: d<0.45λ. Height h₁ is given as: h₁>0.2λ. The aspect ratio of height h₁ to diameter d is given as: h₁/d<1.1. The ratio of height h₂ to height h₁ is given as: 0.4<h₂/h₁<0.6. The structure length l is given as: 0.3λ<(l−d)<00.5λ. It will be understood that the foregoing examples of dimensions are illustrative in nature and are not intended to be construed in a limiting sense. Rather, other dimensions, lengths, diameters, heights, gap distances, aspect ratios, etc., may be employed, as will be understood by one of skill in the art.

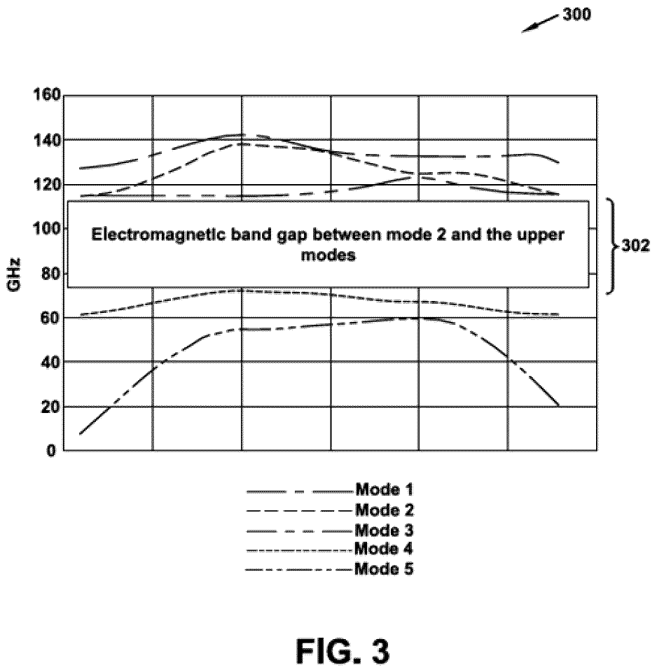

FIG. 3 illustrates a graph 300 of different resonator modes exhibited by the EBG structure, in accordance with one or more features described herein. In the illustrated example, five modes are depicted. Modes 1 and 2 are lower frequency modes, while modes 3, 4, and 5 are higher frequency modes. None of the illustrated modes 1-5 operates in the range of approximately 73 GHz to approximately 115 GHz. This is a band gap 302 in which the radar sensor can operate. That is, radar signals having a frequency within the band gap 302 can be transmitted and received efficiently. It will be understood the foregoing example is provided for illustrative purposes, and not to be construed in a limiting manner. Rather, different numbers of modes operating at different frequencies, different band gap ranges, etc., can be employed in accordance with various features described herein as will be understood by one of skill in the art.

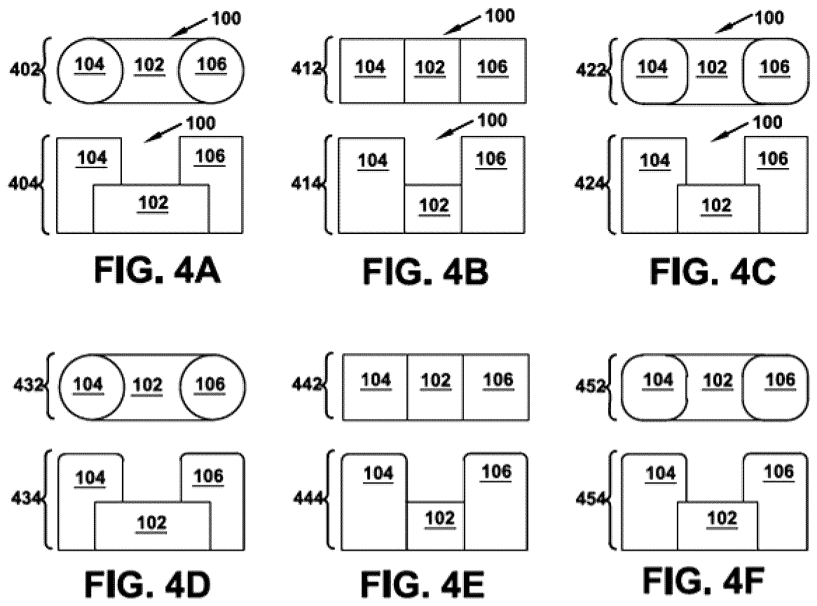

FIGS. 4A-4F Illustrate different configurations the EBG structure, in accordance with one or more features described herein. FIG. 4A shows a top down view 402 and a side view 404 of the EBG structure 100. From these two views in the example of FIG. 4A, it can be seen that the first and second posts 104, 106 are cylindrical.

FIG. 4B shows a top down view 412 and a side view 414 of the EBG structure 100. From these two views in the example of FIG. 4B, it can be seen that the first and second posts 104, 106 are columnar.

FIG. 4C shows a top down view 422 and a side view 424 of the EBG structure 100. From these two views in the example of FIG. 4C, it can be seen that the first and second posts 104, 106 are columnar with chamfered sidewalls, which give the posts 104, 106 a rounded appearance in the top down view 422.

FIG. 4D shows a top down view 432 and a side view 434 of the EBG structure 100. From these two views in the example of FIG. 4D, it can be seen that the first and second posts 104, 106 are cylindrical with chamfered tops, which give the posts 104, 106 a rounded appearance in the side view 434.

FIG. 4E shows a top down view 442 and a side view 444 of the EBG structure 100. From these two views in the example of FIG. 4E, it can be seen that the first and second posts 104, 106 are columnar with chamfered tops, which give the posts 104, 106 a rounded appearance in the side view 444.

FIG. 4F shows a top down view 452 and a side view 454 of the EBG structure 100. From these two views in the example of FIG. 4F, it can be seen that the first and second posts 104, 106 are columnar with chamfered tops and sidewalls, which give the posts 104, 106 a rounded appearance in both the top down view 452 and the side view 454.

Rounded corners on the posts 104, 106 are beneficial for manufacturing and do not adversely affect the functionality of the EBG structure 100. Additional edge chamfering and/or draft angles can be employed to facilitate manufacturing in, e.g., a plastic injection molding process with metal coating.

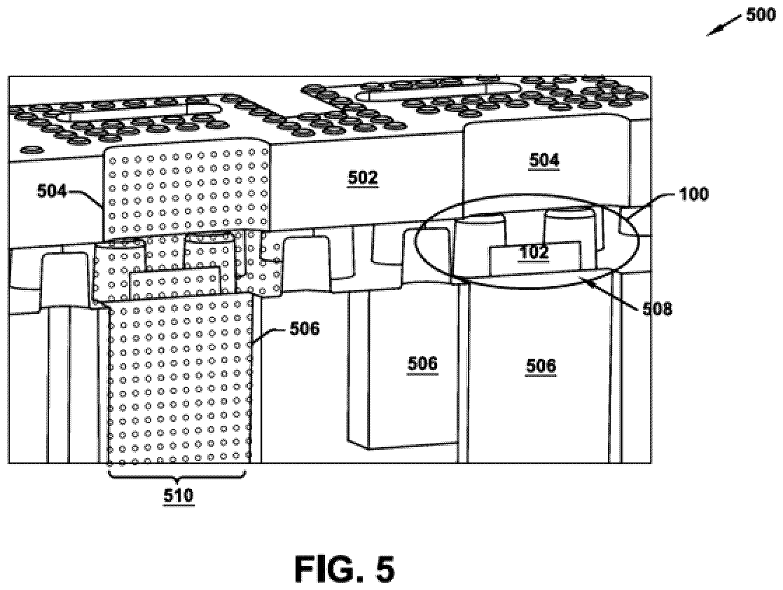

FIG. 5 illustrates a cutaway view of a portion of a radar sensor 500 that employes the described EBG structure 100, in accordance with one or more features described herein. The radar sensor 500 comprises a printed circuit board (PCB) 502 with waveguide channels 504 passing there through. Waveguide structure 506 is also shown. The EBG structures 100 are positioned so that they touch the waveguide structure 506 in such a way as to continue the broad sides of the waveguide structures of the waveguide antenna without any step offs. That is, an upper edge 508 of the broad side of the waveguide structure 506 is flush with a lower edge of a broad side of the bridge 102 of the EBG structure 100, and thus the EBG structure 100 continues or extends the broad side of the waveguide structure 506 toward the PCB 502, as illustrated. By positioning the EBG structures 100 in this manner, RF performance is improved and insertion loss is reduced. Also shown is the electrical field distribution 510 (illustrated as a dot matrix) of the mode used by the radar sensor 500. The electrical field distribution 510 has its maximum in the center of the waveguide.

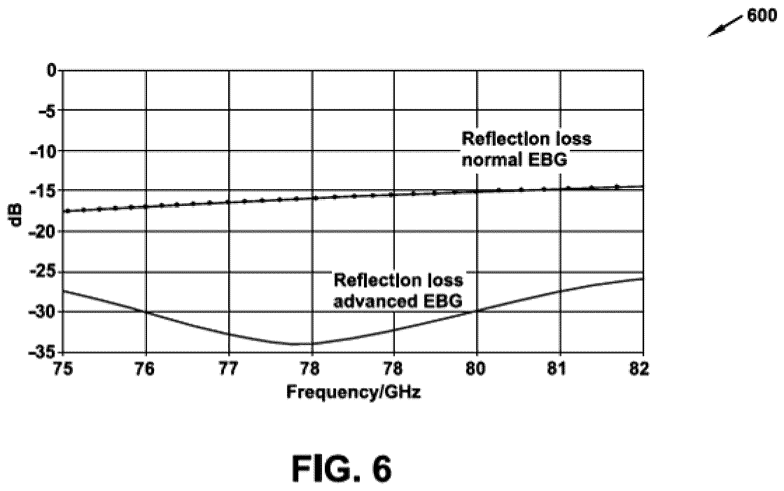

FIG. 6 illustrates a graph 600 showing reflection loss for a conventional EBG structure and the herein-described double post EBG structure 100. As can be seen, reflection loss for a conventional EBG structure is in the range of approximately −14 dB to approximately −18 dB. In contrast, the reflection loss for the double post EBG structure described herein is in the range of approximately −26 dB to approximately −34 dB.

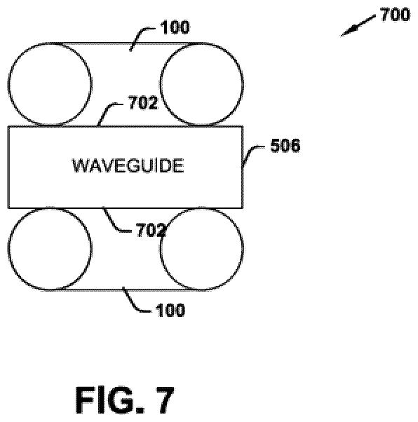

FIG. 7 shows a top down view 700 of the waveguide structure 506 (FIG. 5) with double post EBG structures 100 (FIG. 1) positioned flush with the broad sides 702 of the end of the waveguide structure 506. Although the EBG structures 100 are shown us having cylindrical posts as illustrated in the top down view 402 of FIG. 4A, it will be understood that any of the EBG structure variations shown and FIGS. 4A-4F can be employed in accordance with various features described herein. By positioning the EBG structures 100 flush with the waveguide structure broad sides 702, transmission and reflection loss are improved. This arrangement is multi-chip capable, tolerant of varying gaps between the waveguide and PCB, and robust against offsets between the waveguide and the PCB. Moreover, this arrangement can be used with launcher-in-package technology.

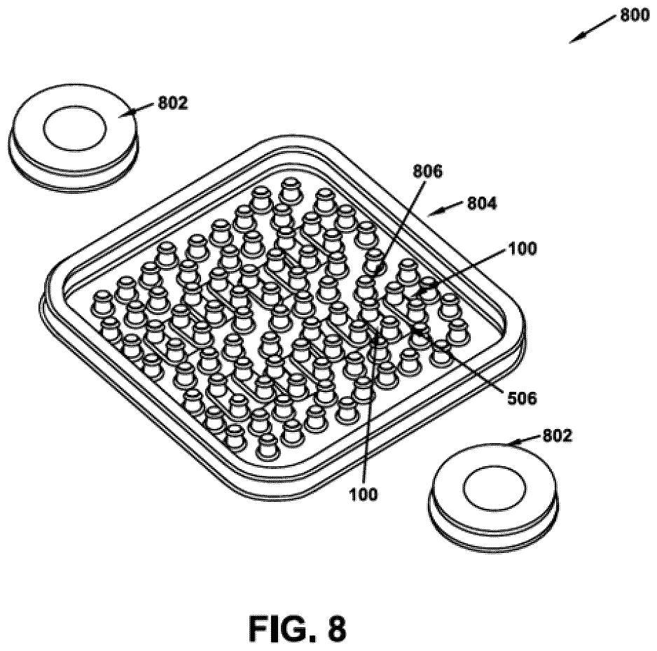

FIG. 8 illustrates a portion of an injection molded waveguide antenna 800, in accordance with one or more features described herein. The waveguide antenna 800 includes two contact points 802, which allow the waveguide antenna 800 to be positioned against and coupled to a PCB without damaging the EBG structures 100. In one embodiment, a spacer structure 804 is provided to protect the EBG structures from damage. The spacer structure 804 surrounds the area where the EBG structures 100 and waveguide structures 506 are disposed, referred to herein as the EBG region. A plurality of waveguide structures 506 extending through the waveguide antenna 800 are also shown between pairs of EBG structures 100, as described herein with regard to various aspects. The EBG structures 100 are positioned flush with the broad sides (longer sides) of the waveguide structures 506. In one embodiment, single post EBG structures 806 are positioned flush with the narrow sides (shorter sides) of the waveguide structures 506. The waveguide structures 506 can be arranged symmetrically or asymmetrically on the waveguide antenna 800 and improve reflection loss.

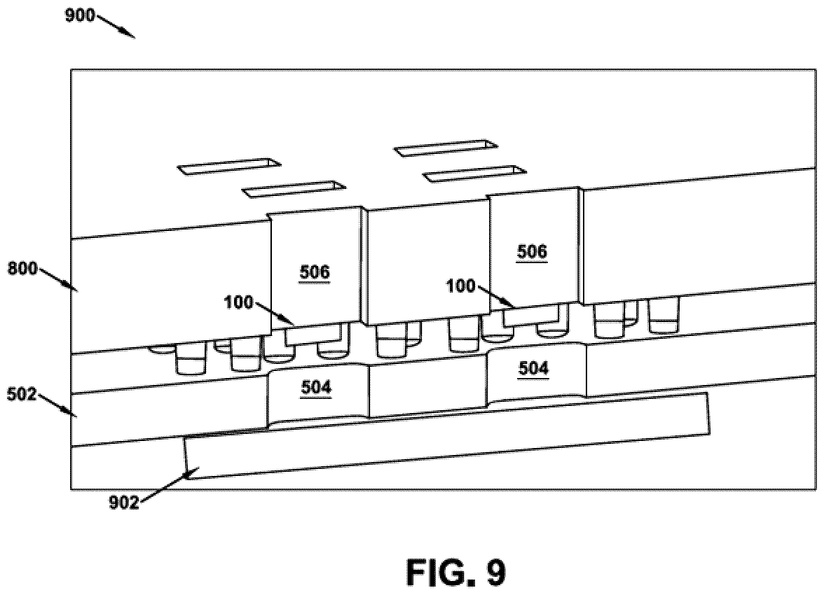

FIG. 9 illustrates a cross-sectional view of a radar sensor 900 comprising the waveguide antenna 800 coupled to a PCB 502, which in turn is coupled to an MMIC 902. Also visible are the waveguide structures 506, the double post EBG structures 100, and the PCB waveguide channels 504. The EBG structures, both single post and double post, are positioned on the waveguide antenna surface that faces the PCB 502 and aligned with the MMIC 902 on the opposite side of the PCB 502. This has the benefit of optimizing transmission and reflection loss, providing good channel coupling between waveguide structures 506 and suppression of parallel plate modes. In this example, the radar sensor 900 can utilize the electromagnetic band gap between modes 2 and 3 (FIG. 3) of the EBG structures 100.

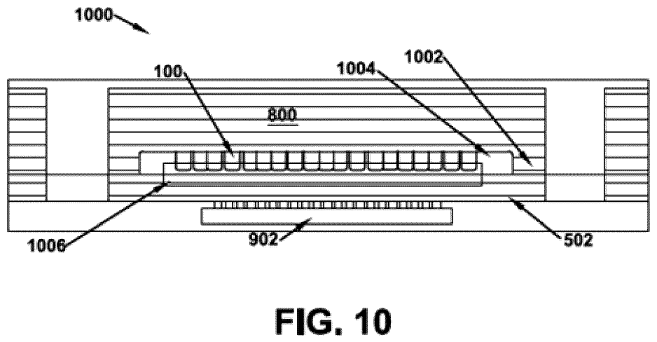

FIG. 10 is an illustration of a radar sensor 1000, showing the waveguide antenna 800 coupled to the PCB 502 at a contact surface 1002. The waveguide antenna comprises a recessed area 1004 in which the EBG structures 100 are positioned such that a nominal gap 1006 is formed between the EBG structures 100 and the PCB 502. The MMIC 902 is coupled to the PCB 502 opposite the recessed area 1004 of the waveguide antenna 800.

The width of the nominal gap 106 can be designed to mitigate or avoid mechanical stress on the EBG structures 100 by ensuring that the EBG structures 100 do not touch the PCB 502. Parameters to be considered when selecting gap width can include EBG height tolerance, bending and warping of the waveguide antenna 800 in the PCB 502, part stiffness of the PCB 502 and the waveguide antenna 800, etcetera. A geometric center of the contact points of the PCB 502 and waveguide antenna 800 can be aligned to a geometric center of the MMIC.

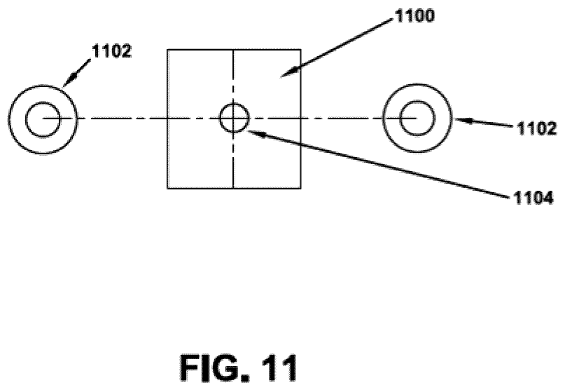

FIG. 11 illustrates a radio frequency (RF) chip 1100 positioned between two contact points 1102 for coupling a waveguide to a PCB, in accordance with one or more features described herein. In one embodiment, the RF chip 1100 is an MMIC. A geometric center 1104 of the RF chip is shown and coincides with a geometric center of the two contact points 1102.

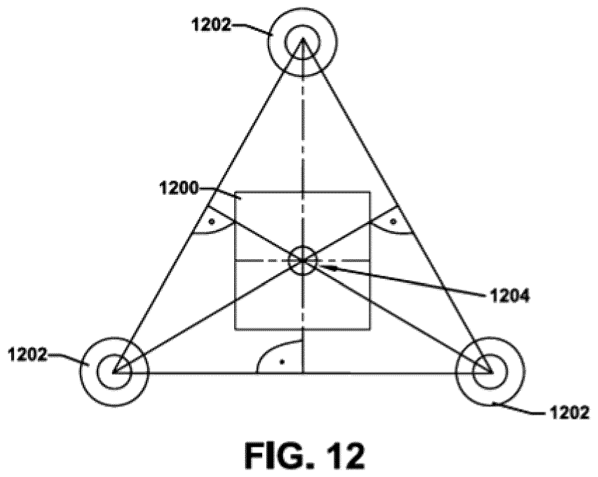

FIG. 12 illustrates a radio frequency (RF) chip 1200 positioned between three contact points 1202 for coupling a waveguide to a PCB, in accordance with one or more features described herein. In one embodiment, the RF chip 1200 is an MMIC. A geometric center 1204 of the RF chip is shown and coincides with a geometric center of the three contact points 1202.

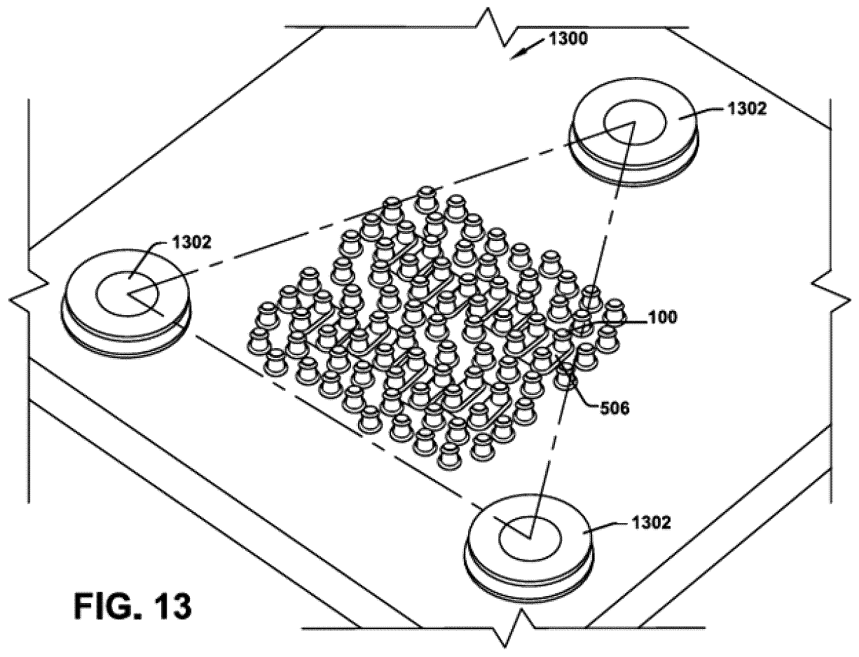

FIG. 13 illustrates a waveguide antenna 1300 having disposed therein waveguide structures 506 with double post EBG structures 100 positioned flush with the broad sides of the waveguide structures 506. Also shown are three contact points 1302 for coupling the waveguide antenna 1300 to a PCB. The three contact points 1302 are positioned so that their geometric center coincides with a geometric center of the EBG structures. The three contact points 1302 can be coupled (e.g., via a screw or other fastener) to corresponding contact points on the PCB (not shown) that also has a MMIC (not shown) disposed on an opposite side of the PCB relative to the waveguide antenna 1300. The contact points on the PCB can be arranged so that their geometric center coincides with a geometric center of the MMIC. In this manner, the EBG devices 100 and waveguide structures 506 can be aligned with the MMIC.

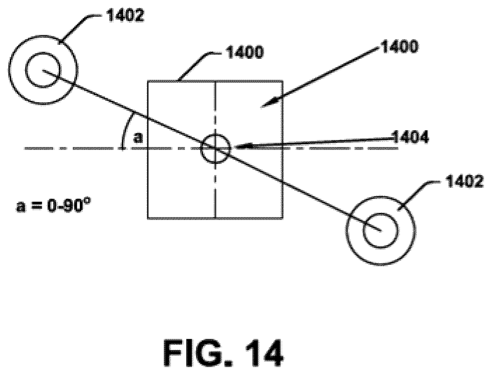

FIG. 14 illustrates a radio frequency (RF) chip 1400 positioned between two contact points 1402 for coupling a waveguide antenna to a PCB, in accordance with one or more features described herein. In one embodiment, the RF chip 1400 is an MMIC. A geometric center 1404 for the RF chip is shown and coincides with a geometric center of the two contact points 1402. The contact points 1402 are arranged at an angle to show that they need not be positioned along any particular axis, but rather can be positioned at any angle so long as their geometric center coincides with the geometric center 1404 of the MMIC.

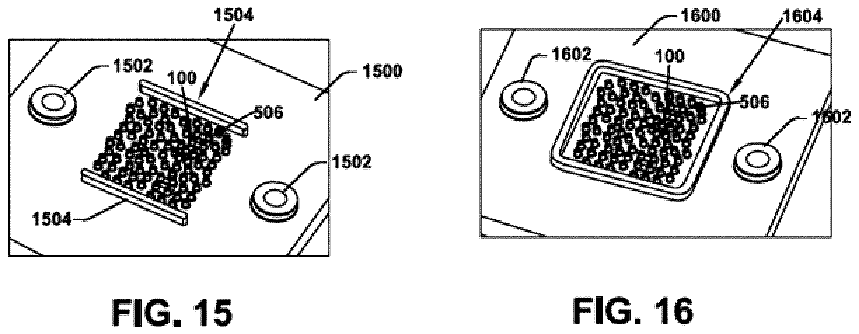

FIG. 15 illustrates a waveguide antenna 1500 having disposed thereon waveguide structures 506 with double post EBG structures 100 positioned flush with the broad sides of the waveguide structures 506. Also shown are two contact points 1502 for coupling the waveguide antenna 1500 to a PCB. The waveguide antenna 1500 also comprises EBG protection edges 1504 on either side of the EBG region that provide mechanical protection to the EBGs 100 so that the PCB, when coupled to the waveguide antenna 1500, does not damage the EBGs 100.

FIG. 16 illustrates a waveguide antenna 1600 having disposed thereon waveguide structures 506 with double post EBG structures positioned flush with the broad sides of the waveguide structures 506. Also shown are two contact points 1602 for coupling the waveguide antenna 1600 to a PCB. The waveguide antenna 1600 also comprises protection edges 1604 surrounding the EBG region to provide mechanical protection to the EBG structures 100 so that the PCB, when coupled to the waveguide antenna 1600, does not damage the EBG structures 100. The pressing edges 1604 also provide shielding to the EBG structures 100, which can facilitate mitigating cavity modes and the like.

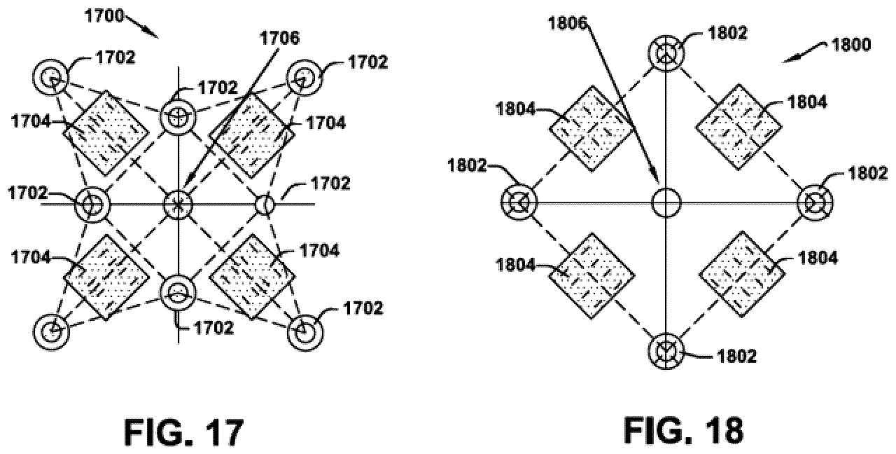

FIG. 17 illustrates a four-chip arrangement 1700 that uses eight contact points 1702, in accordance with one or more features described herein. Four MMICs 1704 are shown, with eight contact points 1702 arranged in the illustrated pattern. A geometric center 1706 of the four MMICs is also shown and coincides with a geometric center of the eight contact points 1702. The geometric center 1706 can also coincide with a geometric center of the PCB (not shown) on which the MMICs are mounted and a geometric center of the waveguide antenna (not shown) coupled to the PCB. Aligning the geometric centers of the PCB, the waveguide antenna, the contact points, and the MMIC is beneficial to accommodate thermal expansion and contraction.

The illustrated arrangement allows MMICs to share contact points, which reduces an overall number of contact points needed. For instance, and the illustrated example, each of the four MMICs 1704 is positioned between three of the eight contact points 1702. Fewer contact points correlates to increased tolerance of thermal expansion and contraction.

FIG. 18 illustrates a four-chip arrangement 1800 that uses four contact points 1802, in accordance with one or more features described herein. Four MMICs 1804 are shown, with four contact points 1802 arranged in the illustrated pattern. A geometric center 1806 of the four MMICs is also shown and coincides with a geometric center of the four contact points 1802. The geometric center 1806 can also coincide with a geometric center of the PCB (not shown) on which the MMICs are mounted and a geometric center of the waveguide antenna (not shown) coupled to the PCB. Aligning the geometric centers of the PCB, the waveguide antenna, the contact points, and the MMIC is beneficial to accommodate thermal expansion and contraction.

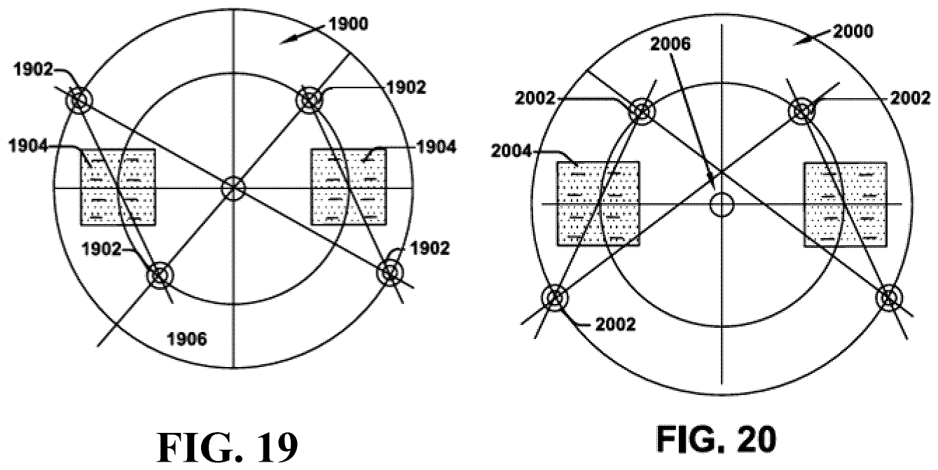

FIG. 19 illustrates a two-chip arrangement 1900 that uses four contact points 1902, in accordance with one or more features described herein. Two MMICs 1904 are shown, with four contact points 1902 arranged in the illustrated parallelogram pattern. A geometric center 1906 of the two MMICs is also shown and coincides with a geometric center of the four contact points 1902. The geometric center 1906 can also coincide with a geometric center of the PCB (not shown) on which the MMICs are mounted and a geometric center of the waveguide antenna (not shown) coupled to the PCB.

FIG. 20 illustrates a two-chip arrangement 2000 that uses four contact points 2002, in accordance with one or more features described herein. Two MMICs 2004 are shown, with four contact points arranged in the illustrated trapezoidal pattern. A geometric center 2006 of the two MMICs is also shown and coincides with a geometric center of the four contact points 2002. The geometric center 2006 can also coincide with a geometric center of the PCB (not shown) on which the MMICs are mounted and a geometric center of the waveguide antenna (not shown) coupled to the PCB.

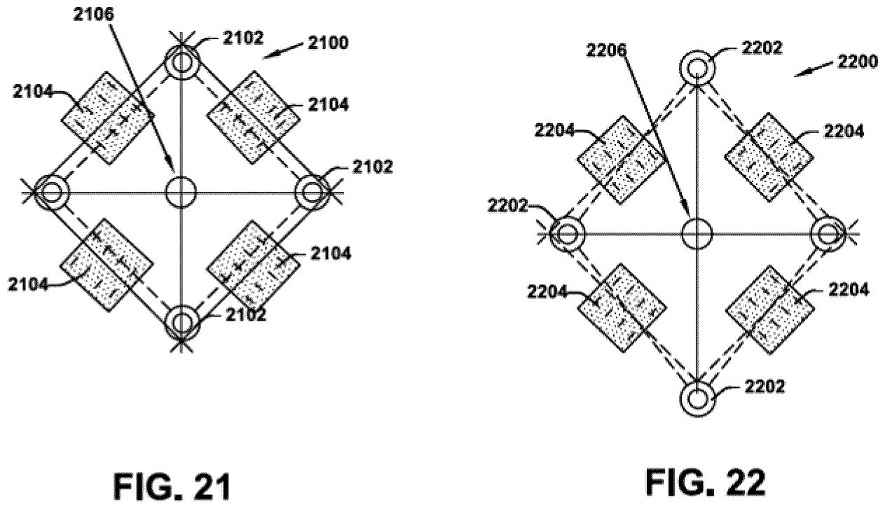

FIG. 21 illustrates a four-chip arrangement 2100 that uses four contact points 2102, in accordance with one or more features described herein. Four MMICs 2104 are shown, with four contact points 2102 arranged in the illustrated pattern. The contact points 2102 are arranged with a ⅓ offset from the chip center to increase design freedom with regard to antenna waveguide placement and PCB design.

A geometric center 2106 of the four MMICs is also shown and coincides with a geometric center of the four contact points 2102. The geometric center 2106 can also coincide with a geometric center of the PCB (not shown) on which the MMICs are mounted and a geometric center of the waveguide antenna (not shown) coupled to the PCB.

FIG. 22 illustrates a four-chip arrangement 2200 that uses four contact points 2202, in accordance with one or more features described herein. Four MMICs 2204 are shown, with four contact points 2202 arranged in the illustrated diamond pattern. A geometric center 2206 of the four MMICs is also shown and coincides with a geometric center of the four contact points 2202. The geometric center 2106 can also coincide with a geometric center of the PCB (not shown) on which the MMICs are mounted and a geometric center of the waveguide antenna (not shown) coupled to the PCB. The diamond arrangement around the geometric center 2206 of the MMICs, the PCB, and the waveguide antenna improves design freedom in antenna placement and PCB design.

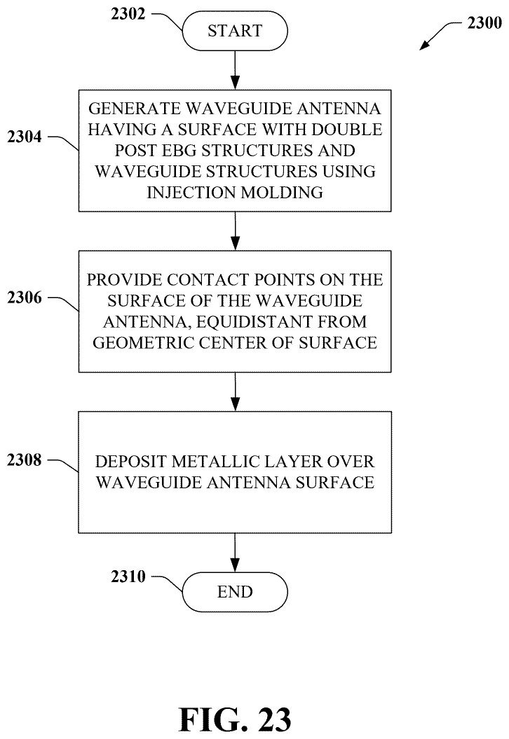

FIG. 23 illustrates an exemplary methodology relating to manufacturing an injection molded waveguide antenna for a radar sensor, the waveguide antenna comprising waveguide structures positioned flush with EBG structures disposed on a surface of the waveguide antenna that contacts a PCB. While the methodology is shown and described as being a series of acts that are performed in a sequence, it is to be understood and appreciated that the methodology is not limited by the order of the sequence. For example, some acts can occur in a different order than is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodology can be stored in a computer-readable medium, displayed on a display device, and/or the like.

Turning now to FIG. 23, a methodology 2300 is illustrated for manufacturing a waveguide antenna having disposed on a surface thereof double post EBG structures positioned adjacent the broad (longer) sides of waveguide structures extending through the waveguide antenna, in accordance with various aspects described herein. The methodology 2300 begins at 2302. At 2304, a waveguide antenna is generated to have a surface on which are disposed double post EBG structures positioned adjacent to and flush with broad sides of waveguide structures extending through the waveguide antenna. In one embodiment, the waveguide antenna and the surface features are generated using an injection molding technique. The waveguide structures (e.g., slots or the like), according to one example, have four sides, two of which are longer than the other two. The EBG structures are disposed adjacent to and flush with the longer sides of the waveguide structures.

At 2306, contact points on the surface of the waveguide antenna are provided in locations that are equidistant from a geometric center of the surface at the waveguide. In one embodiment, the contact points are formed during injection molding along with the waveguide structures and the EBG structures. The contact points can be arranged to be equidistant from a geometric center of the waveguide antenna. At 2308, a metallic layer is deposited over the waveguide structures, the EBG structures, and the waveguide antenna surface. The metallic layer can be formed of any conductive material. Examples of the conductive material include nickel, aluminum, silver, gold, a material stack (e.g., NiAu, NiCuAg), or the like. The method terminates at 2310.

Described herein are various technologies according to at least the following examples.

(A1) In an aspect, a radar sensor includes a monolithic microwave integrated circuit (MMIC). The radar sensor also includes a printed circuit board (PCB) coupled to the MMIC. The radar sensor further includes a waveguide antenna coupled to the PCB and having waveguide structures extending through the waveguide antenna to a surface of the waveguide antenna, the surface facing the PCB. The radar sensor further includes double post electromagnetic band gap (EBG) structures disposed adjacent to and flush with broad sides of the waveguide structures on the surface of the waveguide antenna.

(A2) In some embodiments of the radar sensor of (A1), the double post EBG structure includes a bridge portion; a first post disposed at a first end of the bridge portion; and a second post disposed at a second end of the bridge portion.

(A3) In some embodiments of the radar sensor of (A2), the first post and the second post are of a first height and the bridge portion is of a second height that is based on the first height.

(A4) In some embodiments of the radar sensor of (A3), the ratio of the second height to the first height is between 0.4 and 0.6.

(A5) In some embodiments of the radar sensor of at least one of (A1)-(A4), the double post EBG structure has a plurality of resonator modes, and the EBG structure provides an operational band gap between a second resonator mode and third resonator mode of the plurality of resonator modes.

(A6) In some embodiments of the radar sensor of at least one of (A1)-(A5), the waveguide, the waveguide structures, and the double post EBG structures are injection molded so that the EBG structures are integral to the surface of the waveguide antenna.

(A7) In some embodiments of the radar sensor of at least one of (A1)-(A6), wherein the double post EBG structures are disposed a recessed area of the surface of the waveguide antenna.

(A8) In some embodiments of the radar sensor of at least one of (A1)-(A7), the waveguide structures and the double post EBG structures are disposed in an EBG region of the surface of the waveguide antenna, and the EBG region is aligned with the MMIC on an opposite side of the PCB.

(A9) In some embodiments of the radar sensor of (A8), the PCB and the waveguide antenna further comprising contact points positioned symmetrically about a geometric center of the MMIC.

(A10) In some embodiments of the radar sensor of at least one of (A1)-(A9), the radar sensor further includes single post EBG structures disposed adjacent to and flush with narrow sides of the waveguide structures on the surface of the waveguide antenna.

(A11) In some embodiments of the radar sensor of at least one of (A1)-(A10), the radar sensor further includes contact points on the PCB and the waveguide antenna for coupling the PCB to the waveguide antenna, the contact points on the PCB being aligned with the contact points on the waveguide antenna.

(A12) In some embodiments of the radar sensor of (A11), the contact points on the PCB are positioned equidistantly from a geometric center of the PCB, and the contact points on the waveguide antenna are positioned equidistantly from a geometric center of the waveguide antenna.

(A13) In some embodiments of the radar sensor of (A12), the geometric centers of the PCB and the waveguide antenna are aligned when the PCB and the waveguide are coupled together at the contact points.

(A14) In some embodiments of the radar sensor of (A13), the geometric centers of the PCB and the waveguide antenna are further aligned with a geometric center of the MMIC.

(A15) In some embodiments of the radar sensor of (A14), the geometric centers of the PCB, the waveguide antenna, and the MMIC are further aligned with a geometric center of an EBG region on the surface of the waveguide antenna, the EBG region comprising a plurality of waveguide structures and double post EBG structures.

(B1) In another aspect, an electromagnetic band gap (EBG) structure for a radar waveguide antenna includes a bridge portion; a first post disposed at a first end of the bridge portion; and a second post disposed at a second end of the bridge portion. Further, a height of the first post and the second post is based on a height of the bridge portion.

(B2) In some embodiments of the EBG structure of (B1), the EBG structure is disposed adjacent to and flush with a waveguide structure on a waveguide antenna.

(B3) In some embodiments of the EBG structure of at least one of (B1)-(B2), the EBG structure has a plurality of resonator modes, and the EBG structure provides an operational band gap between a second resonator mode and third resonator mode of the plurality of resonator modes.

(C1) In another aspect, method of manufacturing a waveguide antenna includes injection molding a waveguide antenna having a waveguide structure extending through the waveguide antenna to a surface thereof and double post electromagnetic band gap (EBG) structures disposed on the surface of the waveguide antenna adjacent to and flush with broad sides of the waveguide structure. The method further includes providing contact points on the surface of the waveguide antenna for coupling the waveguide antenna to a printed circuit board (PCB), the contact points being equidistant from a geometrical center of the surface of the waveguide antenna. The method also includes depositing a metallic layer over the surface of the waveguide antenna. The double post EBG structure includes a bridge portion; a first post disposed at a first end of the bridge portion; and a second post disposed at a second end of the bridge portion.

(C2) In some embodiments of the method of (C1), the method also includes providing a recessed area in the surface of the waveguide antenna, the waveguide structure and the EBG structures being disposed in the recessed area, the recessed area comprising: a geometric center that coincides with the geometric center of the waveguide antenna; and a depth that is greater than a height of the first and second posts of the EBG structures.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A radar sensor, comprising:
a monolithic microwave integrated circuit (MMIC);
a printed circuit board (PCB) coupled to the MMIC;
a waveguide antenna coupled to the PCB and having waveguide structures extending through the waveguide antenna to a surface of the waveguide antenna, the surface facing the PCB; and
double post electromagnetic band gap (EBG) structures disposed adjacent to and flush with broad sides of the waveguide structures on the surface of the waveguide antenna.

2. The radar sensor of claim 1, wherein the double post EBG structure comprises:
a bridge portion;
a first post disposed at a first end of the bridge portion; and
a second post disposed at a second end of the bridge portion.

3. The radar sensor of claim 2, wherein the first post and the second post are of a first height and the bridge portion is of a second height that is based on the first height.

4. The radar sensor of claim 3, wherein the ratio of the second height to the first height is between 0.4 and 0.6.

5. The radar sensor of claim 1, wherein the double post EBG structure has a plurality of resonator modes, and wherein the EBG structure provides an operational band gap between a second resonator mode and third resonator mode of the plurality of resonator modes.

6. The radar sensor of claim 1, wherein the waveguide, the waveguide structures, and the double post EBG structures are injection molded so that the EBG structures are integral to the surface of the waveguide antenna.

7. The radar sensor of claim 1, wherein the double post EBG structures are disposed a recessed area of the surface of the waveguide antenna.

8. The radar sensor of claim 1, wherein the waveguide structures and the double post EBG structures are disposed in an EBG region of the surface of the waveguide antenna, and wherein the EBG region is aligned with the MMIC on an opposite side of the PCB.

9. The radar sensor of claim 8, the PCB and the waveguide antenna further comprising contact points positioned symmetrically about a geometric center of the MMIC.

10. The radar sensor of claim 1, further comprising single post EBG structures disposed adjacent to and flush with narrow sides of the waveguide structures on the surface of the waveguide antenna.

11. The radar sensor of claim 1, further comprising contact points on the PCB and the waveguide antenna for coupling the PCB to the waveguide antenna, the contact points on the PCB being aligned with the contact points on the waveguide antenna.

12. The radar sensor of claim 11, wherein the contact points on the PCB are positioned equidistantly from a geometric center of the PCB, and wherein the contact points on the waveguide antenna are positioned equidistantly from a geometric center of the waveguide antenna.

13. The radar sensor of claim 12, wherein the geometric centers of the PCB and the waveguide antenna are aligned when the PCB and the waveguide are coupled together at the contact points.

14. The radar system of claim 13, wherein the geometric centers of the PCB and the waveguide antenna are further aligned with a geometric center of the MMIC.

15. The radar system of claim 14, wherein the geometric centers of the PCB, the waveguide antenna, and the MMIC are further aligned with a geometric center of an EBG region on the surface of the waveguide antenna, the EBG region comprising a plurality of waveguide structures and double post EBG structures.

16. An electromagnetic band gap (EBG) structure for a radar waveguide antenna comprising;
a bridge portion;
a first post disposed at a first end of the bridge portion; and
a second post disposed at a second end of the bridge portion;
wherein a height of the first post and the second post is based on a height of the bridge portion.

17. The EBG structure of claim 16, disposed adjacent to and flush with a waveguide structure on a waveguide antenna.

18. The EBG structure of claim 16, wherein the EBG structure has a plurality of resonator modes, and wherein the EBG structure provides an operational band gap between a second resonator mode and third resonator mode of the plurality of resonator modes.

19. A method of manufacturing a waveguide antenna, comprising:
injection molding a waveguide antenna having a waveguide structure extending through the waveguide antenna to a surface thereof and double post electromagnetic band gap (EBG) structures disposed on the surface of the waveguide antenna adjacent to and flush with broad sides of the waveguide structure;
providing contact points on the surface of the waveguide antenna for coupling the waveguide antenna to a printed circuit board (PCB), the contact points being equidistant from a geometrical center of the surface of the waveguide antenna; and
depositing a metallic layer over the surface of the waveguide antenna;
wherein the double post EBG structure comprises:
a bridge portion;
a first post disposed at a first end of the bridge portion; and
a second post disposed at a second end of the bridge portion.

20. The method of claim 19, further comprising providing a recessed area in the surface of the waveguide antenna, the waveguide structure and the EBG structures being disposed in the recessed area, the recessed area comprising:
a geometric center that coincides with the geometric center of the waveguide antenna; and
a depth that is greater than a height of the first and second posts of the EBG structures.
